(19) United States
(12) Patent Application Publication
(10) Pub. No.: US 2021/0210256 A1
(43) Pub. Date: Jul. 8, 2021

(54) GLASS SEALED THERMISTOR HAVING SHOCK ABSORBED STRUCTURE

(71) Applicant: LATTRON CO.,LTD., Daejeon (KR)

(72) Inventors: ChungKook LEE, Daejeon (KR); CheolJin JEONG, Daejeon (KR)

(73) Assignee: LATTRON CO.,LTD., Daejeon (KR)

(21) Appl. No.: 17/139,783

(22) Filed: Dec. 31, 2020

(30) Foreign Application Priority Data
Jan. 7, 2020 (KR) 10-2020-0002248

(51) Int. Cl. H01C 1/06; H01C 7/00; H01C 1/02

(52) U.S. Cl. CPC H01C 1/06; H01C 1/02; H01C 7/008

(57) ABSTRACT

A glass sealed thermistor having a shock absorbing structure includes: a thermistor device whose resistance value changes according to temperature; a glass sealing layer that hermetically protects a head and a contact electrode of the glass sealed thermistor; a pair of conductive supporters having an electrical conductor function and a thermistor device support function; a shock absorbing structure formed by surrounding the pair of conductive supporters adjacent to the glass sealing layer; and a coating layer is coated on the glass sealing layer with polymer material.

### BACKGROUND OF THE INVENTION

### 1. Field of the Invention

The present invention relates to a glass sealed thermistor having a shock absorbed structure, and more particularly, to a glass sealed thermistor in which a shock absorber is formed in order to protect a glass sealed layer of the thermistor.

### 2. Description of the Related Art

A thermistor is a semiconductor device whose resistance value changes according to a change in temperature, and can be applied as a temperature sensor in all fields if a temperature range is −50 to 1000° C. Due to its small size and low cost, it is widely used as a temperature sensor for industrial devices, electronic devices, medical devices, and automobiles.

In order to read electrical changes of the thermistor, contact with a pair of lead wires or lead frames, and to protect the thermistor, a sealing layer that is sealed by covering an electrode and lead of the device is formed. When the sealing layer is used at a low temperature, a polymer such as an epoxy resin is used, but a glass is used as a sealing layer to ensure thermal change and reliability at a high temperature of 200° C. or higher.

The glass sealing layer formed of a glass material reduces the reliability of the thermistor because a shock is transmitted to the glass sealing layer when the lead is cut or spread, causing cracks or breakage, resulting in poor sealing effect.

Conventional thermistors generally use circular or quadrangular lead wires, as shown in FIG. 8A, but lead wires may be warped when their diameter or thickness is thin and length is lengthened. A defect may occur in a device, and since a pitch between the lead wires is narrow and easily deformed, there is a problem that additional processes for insulation, such as coating or 25 inserting a tube, as shown in FIG. 8B, are required to secure insulation between the lead wires.

In order to speed up thermal response time of a thermistor, if a head part of the thermistor is miniaturized, a lead wire becomes thinner, and the thinner the lead wire becomes weaker, so it may be easily bent or broken during handling, and defects may occur in a device.

In addition, if the width or thickness of a lead frame is increased to have mechanical durability in a vibration environment, such as an automobile thermistor, the head of the thermistor becomes larger and the thermal response decrease, and there is a problem that the sealing layer is damaged by a shock transmitted when cutting the lead frame.

### SUMMARY OF THE INVENTION

A glass sealed thermistor having a shock absorbing structure according to the present invention to solve the above problem includes: a thermistor device whose resistance value changes according to temperature; a glass sealing layer that hermetically protects a head and a contact electrode of the glass sealed thermistor; a pair of conductive supporters having an electrical conductor function and a thermistor device support function, and a shock absorbing structure formed by surrounding the pair of conductive supporters adjacent to the glass sealing layer,

wherein the conductive supporter includes a lead part in contact with an electrode of the thermistor device; a deformation part that is connected to the lead part and changes in width or thickness; a body part that functions as a support while being connected to the deformation part; a connection part connected to the body part and a circuit board; a protrusion part that is formed outwardly on or around the deformation part; and a coating layer is coated on the glass sealing layer with polymer material.

### BRIEF DESCRIPTION OF THE DRAWINGS

FIG. 1A is a diagram showing a lead frame type glass sealed thermistor having a shock absorbing structure according to the present invention, and FIG. 1B is a diagram showing a lead wire type glass sealed thermistor having a shock absorbing structure according to the present invention.

FIG. 2 is a perspective view showing a glass sealed thermistor using a lead frame according to the present invention.

FIG. 3 is a drawing in which a coating layer mainly composed of a polymer material of a glass sealed thermistor is formed on a lead frame according to the present invention.

FIG. 4 is a diagram showing a glass sealed thermistor in which a protrusion is formed on a lead frame according to the present invention.

FIG. 5 is a modified embodiment of a glass sealed thermistor in which a protrusion is formed on a lead frame according to the present invention and a coating layer containing a polymer material is formed.

FIG. 6A shows an embodiment of the glass sealed thermistor in which a shock absorbing structure is formed including the deformation part protrusion, FIG. 6B shows an embodiment of the glass sealed thermistor in which a shock absorbing structure is formed under the deformation part protrusion, and FIG. 6C shows an embodiment of the glass sealed thermistor in which a shock absorbing structure is formed apart from the deformation part protrusion.

FIG. 7 is another embodiment of a glass sealed thermistor having a shock absorbing structure according to the present invention.

FIG. 8A shows a conventional lead wire type thermistor, and FIG. 8B shows a secure insulation between the lead wires required in the conventional thermistor.

### DETAILED DESCRIPTION OF THE PREFERED EMBODIMENTS

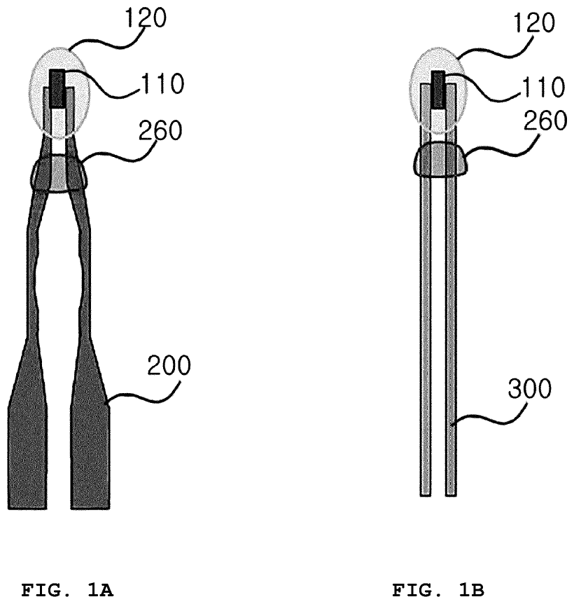

FIG. 1A and FIG. 1B are, respectively, a glass sealed thermistor having a shock absorbing structure according to the present invention, a thermistor device 110 whose resistance value changes according to temperature, a glass sealing layer 120 protecting the thermistor device and a contact terminal hermetically, and a pair of conductive supporters 200, 300 having an electrical conductor function and a thermistor device support function, and a shock absorber 260 formed on the pair of conductive supporters adjacent to the sealing layer.

The sealing layer is a protective layer that provides hermeticity to prevent the thermistor device from being corroded by moisture or chemical components, and is sealed with a polymer resin or glass material as a protective layer to prevent scratches or damage due to physical and thermal shock.

The sealing layer generally uses a polymer such as an epoxy resin when used at a low temperature, but a glass is used as the sealing layer in order to secure thermal change and reliability when used at a high temperature of 200° C. or higher.

Polymer resins are easy and inexpensive to manufacture, and strong against mechanical shock, but have low reliability due to chemical durability and short lifespan. The sealing layer made of glass has high reliability such as chemical and thermal durability, but has a disadvantage of generating cracks or breaking by shock due to properties of glass.

A high reliability thermistor according to the present invention provides a thermistor with improved reliability by forming a sealing layer made of glass and forming a shock absorbing structure that absorbs mechanical shock to prevent cracks or breakage of glass.

The shock absorbing structure is formed in a shape surrounding a pair of conductive supporters adjacent to the sealing layer using an elastic polymer resin. The meaning of adjacency means that it may be adjacent to each other, or may be formed to be adjacent and spaced apart a predetermined distance.

The shock absorbing structure or coating layer is made of a polymer resin as a main component, and a ceramic filler such as silica or titania is added to improve cure shrinkage, thermal expansion mismatch, strength and thermal conductivity.

The conductive supporter is a lead wire or a lead frame. The lead wire may be a circular or rectangular shape having a constant diameter or thickness as shown in FIG. 1B, and a dumet wire is preferable.

The dumet wire is coated with a thin layer of borax on the copper surface to prevent oxidation and improve compatibility with glass. The core wire of the dumet wire is an Fe—Ni alloy and has a similar expansion rate to that of glass, so it is used as a glass sealing wire.

FIG. 1A is a conductive supporter using a lead frame, which is a thin substrate made of Fe—Ni or copper alloy having excellent electrical conductivity and rigidity, and is mainly used in a package for attaching semiconductor chips. Mass production is easy by punching or etching by a mold of a desired shape.

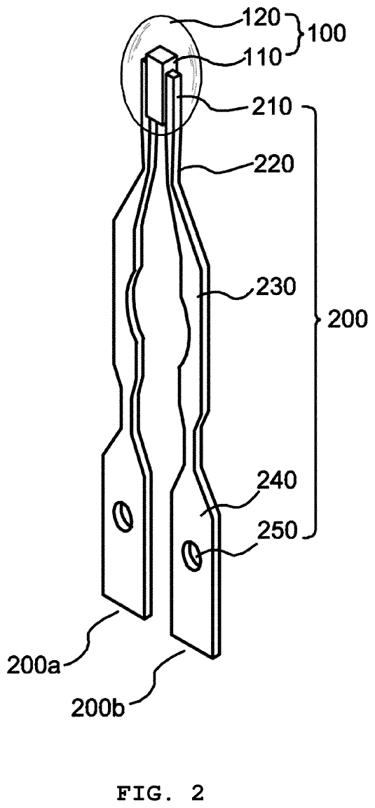

FIG. 2 shows an embodiment in which the present invention is implemented as a lead frame. The lead frame is formed in a pair of 200a, 200b and includes a lead part 210 in contact with an electrode, a deformation part 220 that changes in width and pitch while being connected to the lead part, a body part 230 that functions as a support while being connected to the deformation part, a connection part 240 connected to a circuit board. The lead frame is a change in width or thickness in the length direction, a pitch can be changed in the width direction.

The width of the deformation part 220 is smaller than the width of other parts, so that the sensor can be miniaturized in proportion to the size of a head part 100, thereby improving a thermal response time, and the head part 100 from the connection part 240 can reduce shock such as vibration transmitted.

In addition, the width of the deformation part 220 is smaller than the thickness of the lead frame 200, and the shock transmitted from the connection part or the like may be reduced or blocked by the deformation part.

The shape of the lead frame from the deformation part to the connection part can be deformed to suit the manufacturing process of a thermistor and sensor.

The lead frame 200 may further include an automation part 250 for reinforcing the connection part 240 and using an automated machine for process automation, and the automation part may be formed as a hole.

The head part 100 is a part where the electrode of the thermistor device 110 and the lead part 210 are in contact, and a glass sealing layer 120 encapsulated to protect the thermistor device is formed, and a coating layer 130 for further coating a polymer material may be formed on the glass sealing layer.

The coating layer 130 is to prevent cracking or damage of the sealing layer made of glass, and may be coated with polyimide, epoxy, or other polymer.

The present invention includes a deformation part 220, a body part 230, and a connection part 240 as described above to provide a thermistor device having a shape in which the lead frame 200 of the thermistor device can buffer stress. The deformation part 220 is formed to have a width narrower than the thickness of the lead part 210 and is connected to the deformation part 220 but has a width wider or similar to that of the lead part 210 in the length direction. It may include a body part 230 and a connection part 240 formed with a sufficient width in a length direction, and lead frames 200 of various shapes including various embodiments may be formed.

By forming the width of the deformation part 220 smaller than the thickness of the body part, the shock transmitted to the head part 100 may be alleviated. The width of the deformation part 220 is 0.90 or less compared to the thickness of the lead frame, preferably 0.50 to 0.85.

The body part 230 may be connected to the deformation part 220 but bend to the outside so that a width between the first lead frame 200a and the second lead frame 200b may be widened. In addition, the width of the lead frame can be widened, narrowed, and widened again, and formed into a half-moon-shaped cross section with a round inside. The lower end of the wider body part may be narrowed again and may be connected to the connection part.

The connection part 240 connected to the body part 230 may be formed to have a wider width for mechanical strength and sufficient welding contact area for a solid connection, and an automation hole 250 may be formed to facilitate automation. The body part 230 and the connection part 240 have a shape suitable for a sensor structure, and a width may be determined according to the sensor structure.

The lead frame 200 may be a coated dumet wire, an alloy-type base material having similar properties, or a composite material in which another material is coated on a base material, and may be elastic and light. The coated dumet wire is an Alloy 42 core wire surrounded by Cu and coated with Borax glass.

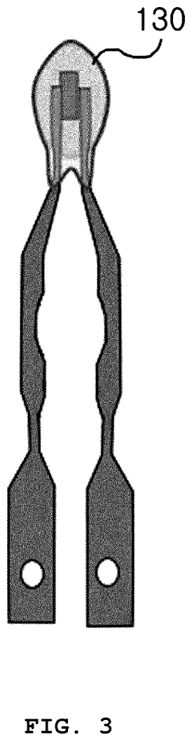

FIG. 3 is a front view showing a form in which a polymer material is further coated on the sealing layer, and the sealing layer may be coated with a polymer material to be protected from mechanical shock. The polymer material may be based on a hard material, and a soft material may be coated on the surface, or may be coated with only one material.

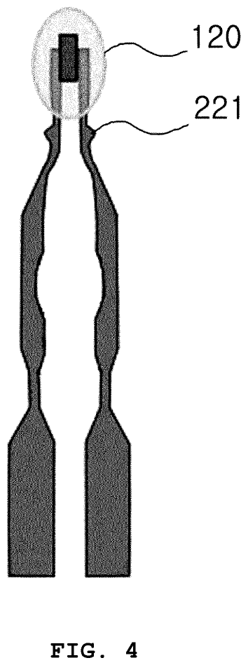

FIG. 4 shows that the protrusions are formed on the glass-sealed thermistor of the shock absorbing structure according to the present invention, thereby forming a deformation part of the lead frame or a protrusion part 221 protruding around the deformation part. The protrusion may keep the position of the glass sealing layer 120 of the head part 100, and is located in the center or the lower part of the deformation part 220 rather than the upper part close to the glass sealing layer 120. When handling, it minimizes the amount of shock transmitted to the glass sealing layer inadvertently.

The protrusion part 221 is formed on the deformation part 220 and is connected with a width narrower than that of the lead part 210, but a body part having a width that is wider or similar to that of the lead part 210 in the longitudinal direction. It may include a body part 230 and a connection part 240 having a sufficient width in a length direction, and a lead frame 200 having various shapes may be formed.

The upper, lower, or central part of the protrusion 221 is smaller than the lead frame thickness, so that even in the thermistor having a miniaturized head part. A shock absorbing structure coated with a polymer material may be formed including the glass sealing layer and the protrusion 221.

The glass sealing layer 120 encapsulated to protect the head part 100 in which the electrode of the thermistor device 110 and the lead part 210 are in contact may be formed. The shock absorbing structure coated with a polymer material may be formed including the glass sealing layer and the protrusion 221.

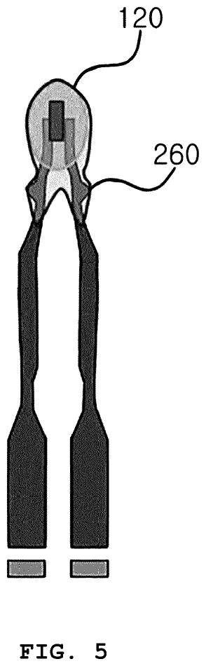

FIG. 5 is a modified embodiment of a sealing type thermistor in which a protrusion is formed on a lead frame according to the present invention, and a coating layer is formed by a polymer material as a main component and a ceramic filler such as silica or titania.

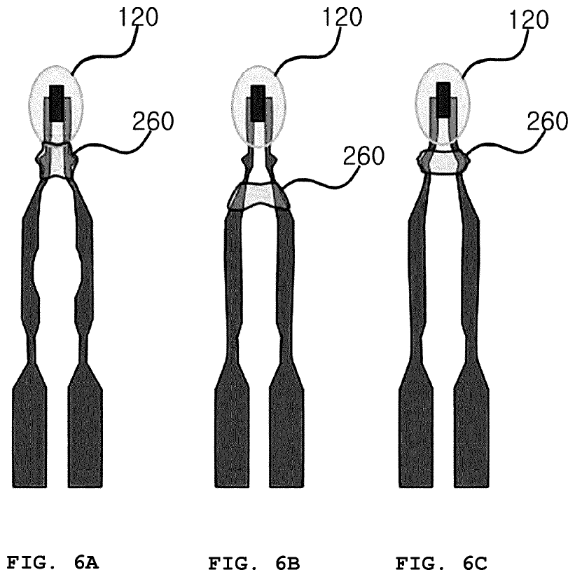

FIG. 6A, FIG. 6B and FIG. 6C are various embodiments of the glass sealed thermistor in which the shock absorbing structure 260 is formed on the deformation part of the lead frame having a protrusion part. The shock absorbing structure may be selectively located on the upper, lower, or intermediate part of the protrusion 221. The shock transmitted from the connection part to the sealing layer is absorbed by the shock absorbing structure and is absorbed once more in the structure of the deformation part 220.

The shock absorbing structure is a polymer such as polyimide, epoxy, or other polymer is an inorganic main component, and a ceramic filler such as silica or titania is added to improve cure shrinkage, thermal expansion mismatch, strength and thermal conductivity.

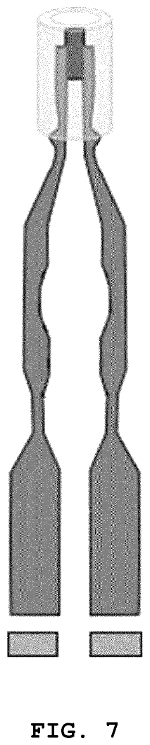

FIG. 7 is another embodiment of the glass sealed thermistor having the shock absorbing structure according to the present invention. In order to prevent damage to the thermistor device and contact terminals from the shock transmitted when opening or cutting the lead frame during operation, a glass tube is headed. It can be used by putting it on the glass sealed thermistor. The protrusion of the deformation part can fix the position of the glass tube.

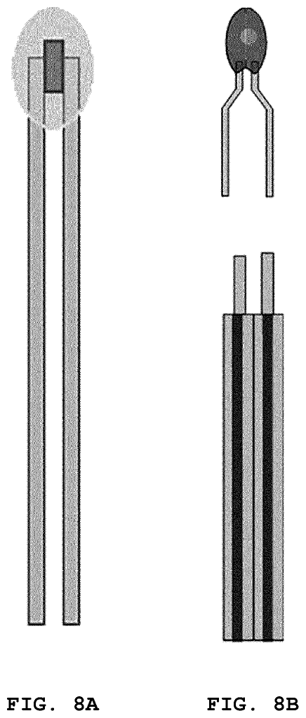

FIG. 8A is a conventional thermistor having a narrow lead pitch, and FIG. 8B is a diagram illustrating a conventional thermistor provided with an external insulating layer to secure insulation between lead wires.

What is claimed is:

1. A glass sealed thermistor having a shock absorbing structure comprising:
a thermistor device whose resistance value changes according to temperature;
a glass sealing layer that hermetically protects a head and a contact electrode of the glass sealed thermistor;
a pair of conductive supporters having an electrical conductor function and a thermistor device support function;
a shock absorbing structure formed by surrounding the pair of conductive supporters adjacent to the glass sealing layer; and
a coating layer is coated on the glass sealing layer with polymer material,
wherein the conductive supporter includes a lead part in contact with an electrode of the thermistor device; a deformation part that is connected to the lead part and changes in width or thickness; a body part that functions as a support while being connected to the deformation part;
a connection part connected to the body part and a circuit board; a protrusion part that is formed outwardly on or around the deformation part.

2. The glass sealed thermistor according to claim 1, wherein the coating layer is extended to the protrusion of the deformation part from the glass sealing layer.

3. The glass sealed thermistor according to claim 1, wherein the coating layer is formed of polyimide, epoxy, or polymer resin including ceramic fillers.

4. The glass sealed thermistor according to claim 1, wherein the width of the deformation part is formed as small as 0.50 to 0.85 compared to the thickness of the lead frame.

5. The glass sealed thermistor according to claim 1, wherein the shock absorbing structure is formed of a polymer resin including a ceramic filler.

6. The glass sealed thermistor according to claim 1, wherein the lead frame includes an automation part in which a hole is formed.
